(19) United States
(12) Patent Application Publication
(10) Pub. No.: US 2002/0107740 A1
(43) Pub. Date: Aug. 8, 2002

(54) Advertising system, advertising method, and computer program for same

(76) Inventor: Yoshinori Abiko, Tokyo (JP)

Correspondence Address: McGinn & Gibb, PLLC, Suite 200, 8321 Old Courthouse Road, Vienna, VA, 22182-3817, US

(21) Appl. No.: 10/059,384

(22) Filed: Jan. 31, 2002

(30) Foreign Application Priority Data
Feb. 2, 2001 (JP) 2001-027469

(51) Int. Cl. G06F 17/60

(52) U.S. Cl. 705/14

(57) ABSTRACT

In an advertising network system, advertising service information is disclosed on the wab page by an advertising server and received by a plurality of company terminals (A1). Advertisement request information is sent from each of the company terminals to the advertising server (A2), and the advertising server generates advertisement selection information which is disclosed on the wab page by an advertising server. The advertisement selection information is received by a customer terminal (A3). The customer terminal sends selection information to the advertising server (A4). The selection information is received by the advertising server (A5), and the selected advertisement is send to the customer terminal (A6). The advertising server sends billing information to the corresponding company terminal (A9).

### BACKGROUND OF THE INVENTION

1. Field of the Invention

The present invention relates to an advertising system for distributing various advertisements of companies to customers via a communication network (such as the Internet), for example, to an advertising network system suitable for use in the case in which advertising having content desired by a customer is distributed.

2. Related Art

Various advertisements from companies have in the past been sent to customers via direct mail or the like. Recently, however, such advertisements are distributed to customers via the Internet.

This type of advertising network system in the past, as depicted in FIG. 8, had company terminals 1, 2, and 3 and a customer terminal 4, these terminals being connected via the Internet NW. The company terminals 1, 2, and 3, send advertisement information M1, M2, and M3 to the customer terminal 4 via the Internet NW. The customer terminal 4 receives the advertisement information M1, M2, and M3. In this advertising network system, the advertisement information M1, M2, and M3 are sent from the company terminals 1, 2, and 3 to the customer terminal 4 via the Internet NW, in accordance with an operation by an operator at each of the companies. At the customer terminal 4, the advertisement information M1, M2, and M3 are displayed, in accordance with an operation by the customers.

The above-noted advertising network system of the past, however, has the following problems.

Specifically, because the advertisement information M1, M2, and M3 are not sent in response to a request from a customer, there are advertisements needed by the customer and advertisements not needed by the customer. For this reason, the customer, after receiving the advertisement information M1, M2, and M3 must read both the needed and unneeded advertisements, this representing waste of time. Additionally, at each company if a customer does not require the advertisement information M1, M2, and M3, sending of this advertisement information is itself wasteful.

Accordingly, it is an object of the present invention, in consideration of the above-noted situation, to provide an advertising system, an advertising method, and an associated computer program, which enables receiving of only a company advertisement that is required by a customer.

### SUMMARY OF THE INVENTION

In order to achieve the above-noted object, a first aspect of the present invention is an advertising system having an advertising server which offers advertising service, a plurality of first terminals which provide advertisements of companies to the advertising server, and a plurality of second terminals of customers which obtain the advertisement from the advertising server, the advertising server, the first terminals, and the second terminals are connected to a communication network, wherein the advertising server comprising: a first means for disclosing detail information of advertising service offered by the advertising server, on the communication network, a second means for receiving from the first terminals advertising request information for requesting to advertise on the communication network, a third means for generating advertisement selection information for causing the customers to select the advertisements based on the advertising request information received from the first terminals, and disclosing the advertisement selection information on the communication network, a fourth means for receiving from the second terminal selection information which the customer selects from the advertisement selection information, a fifth means for sending to the second terminal an advertisement which the customer selected, in accordance with the selection information received from the second terminal so as to perform advertising service, and a sixth means for sending to the first terminal billing information for demanding payment with respect to the advertising service by the advertising server.

The second aspect of the present invention is an advertising system having an advertising server which offers advertising service, a plurality of first terminals which provide advertisements of companies to the advertising server, and a plurality of second terminals of customers which obtain the advertisement from the advertising server, the advertising server, the first terminals, and the second terminals are connected to a communication network, wherein the advertising server comprising: a first means for disclosing detail information of advertising service offered by the advertising server, on the communication network, a second means for receiving from the first terminals advertising request information for requesting to advertise on the communication network, a third means for generating advertisement selection information for causing the customers to select the advertisements based on the advertising request information received from the first terminals, and disclosing the advertisement selection information on the communication network, a fourth means for receiving from the second terminal selection information which the customer selects from the advertisement selection information, a fifth means for sending to the second terminal an advertisement which the customer selected, in accordance with the selection information received from the second terminal so as to perform advertising service, a sixth means for sending to the first terminal first billing information for demanding payment with respect to the advertising service by the advertising server, and a seventh means for sending to the second terminal second billing information for demanding payment with respect to the advertising service by the advertising server.

### BRIEF DESCRIPTION OF THE DRAWINGS

FIG. 1 is a drawing showing the configuration of an advertising network system according to a first embodiment of the present invention.

FIG. 2 is a sequence diagram illustrating the advertising network system shown in FIG. 1.

FIG. 3 is a drawing showing an example of a web page disclosed on the Internet by the advertising server.

FIG. 4 is a drawing showing the configuration of a advertising network system according to a second embodiment of the present invention.

FIG. 5 is a sequence diagram illustrating the advertising network system shown in FIG. 4.

FIG. 6 is a drawing showing the configuration of a advertising network system according to a third embodiment of the present invention.

FIG. 7 is sequence diagram illustrating the advertising network system shown in FIG. 6.

FIG. 8 is a drawing showing the configuration of a conventional advertising network system.

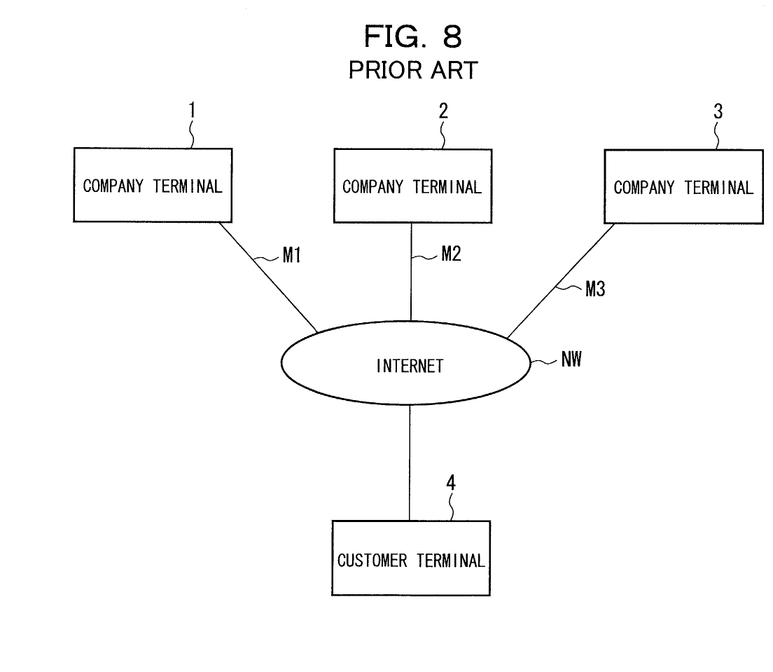

### DETAILED DESCRIPTION OF THE PREFERRED EMBODIMENTS

Embodiments of the present invention are described in detail below, with reference made to relevant accompanying drawings.

(First Embodiment)

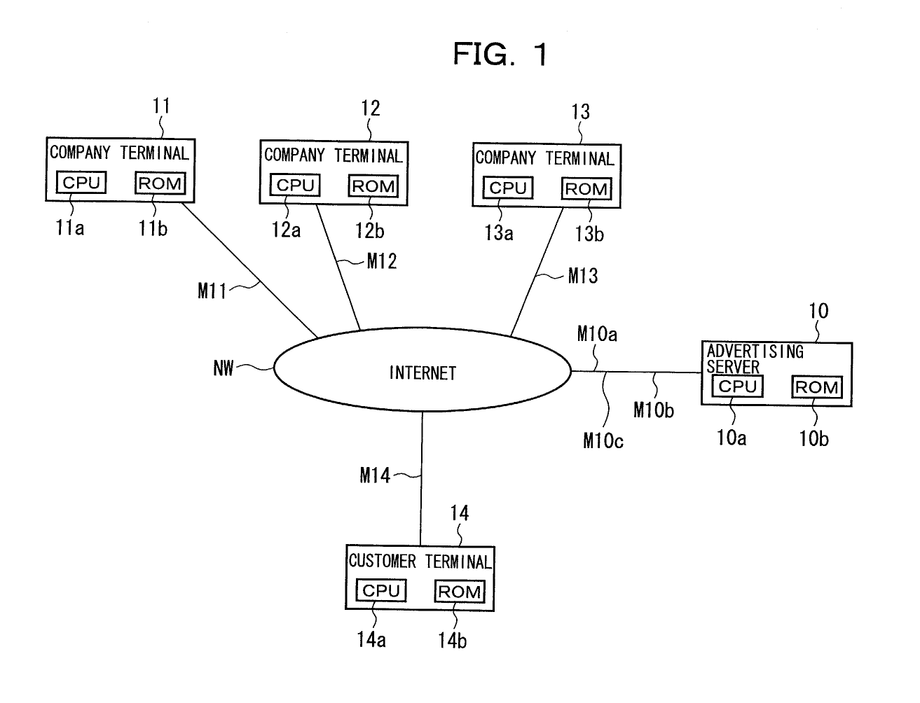

FIG. 1 is shows the configuration of a advertising the Internet NW. It further sends to the company terminals 11, 12, and 13, via the Internet NW, billing information M10c for billing the company for the sending of the advertisements.

The company terminal 11 is, for example, an information processing apparatus such as a personal computer installed in the advertising department of a company, this information processing apparatus having a central processing unit (CPU) 11a, which performs overall control of the company terminal 11, and a ROM 11b, in which is stored a control program for causing the CPU 11a to operate. The company terminal 11 receives the advertising service information M10a via the Internet NW and, based on this advertising service information M10a, sends to the advertising server 10 advertisement request information M11 so as to send an advertisement to the customer terminal 14, via the Internet NW, and further receives billing information M10c. In the same manner, the company terminals 12 and 13 also have CPUs 12a and 13a and ROMs 12b and 13b, receive the advertising service information M10a, send advertisement request information M12 and M13 to the advertising server 10, and receive billing information M10c.

The customer terminal 14 is, for example, an information processing apparatus such as a personal computer installed in the home of a customer, this information processing apparatus having a central processing unit (CPU) 14a, which performs overall control of the customer terminal 14, and a ROM 14b, in which is stored a control program for causing the CPU 14a to operate. The customer terminal 14 receives advertisement selection information M10b via the Internet NW, and sends selection information M14 for selecting a desired company advertisement from the advertisement selection information M10b to the advertising server 10, via the Internet NW, and further receives a company advertisement via the Internet NW.

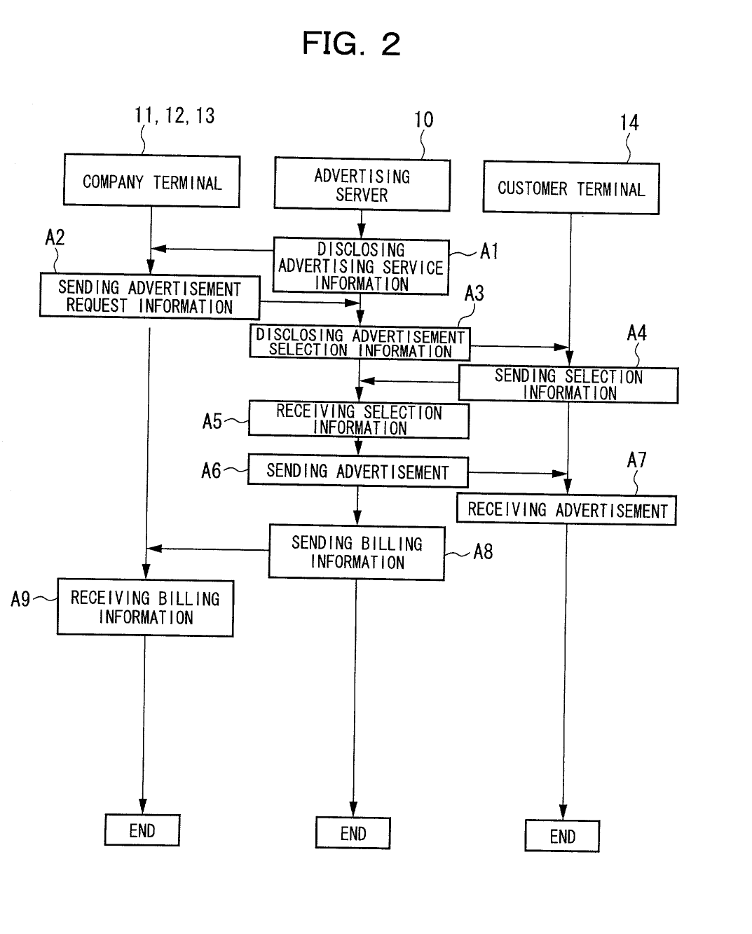

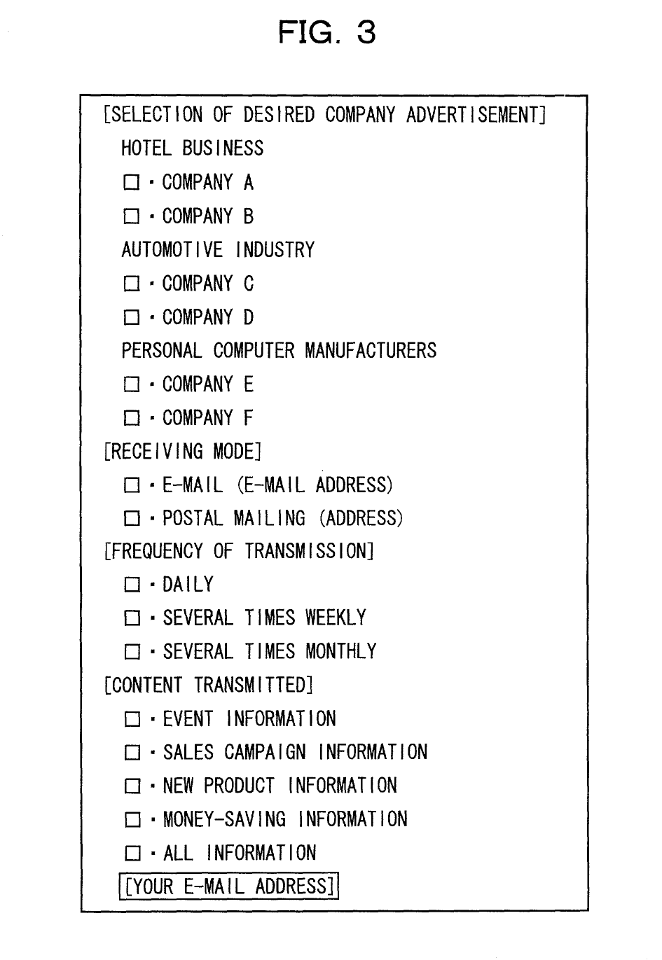

FIG. 2 is a sequence diagram illustrating the advertising network system of FIG. 1, and FIG. 3 is a drawing showing an example of a web page having the advertisement selection information M10b disclosed on the Internet NW by the advertising server 10.

The processing in the advertising network system according to the present invention is described below, with reference made to FIG. 2 and FIG. 3.

As shown in FIG. 2, advertising service information M10a from the advertising server 10 is disclosed on the Internet NW (step A1, advertising service information disclosure). The advertising service information M10a is received via the Internet NW by the company terminals 11, 12, and 13. The company terminals 11, 12, and 13, study the content of the advertising service, based on the advertising service information M10a, and each sends to the advertisement server 10 advertising request information M11, M12, and M13, via the Internet NW (step A2, advertisement request information sending processing)

The advertisement request information M11, M12, and M13 is received by the advertising server 10 via the Internet NW. The advertising server 10, based on the advertisement request information M11, M12, and M13, generates advertisement selection information M10b, and discloses this advertisement selection information M10b on the Internet NW (step A3, advertisement selection information disclosure processing). A web page having the advertisement selection information M10b, as shown in FIG. 3, has selection categories corresponding to [Selection of Desired Company Advertisement], [Receiving Mode], [Frequency of Transmission], and [Content Transmitted], with each category having check boxes that can be checked to indicate the wishes of the customer. On this web page, a field is provided for the entry of the [Customer E-mail Address]. The advertisement selection information M10b is received by the customer terminal 14 via the Internet NW, and the selection information M14 is sent from the customer terminal 14 to the advertising server 10 via the Internet NW (step A4, selection information sending processing).

The selection information M14 is received by the advertising server 10 via the Internet NW (step A5, selection information receiving processing). The advertising server 10, based on the selection information M14, selects a company advertisement based on the selection information M14, and sends the advertisement to the customer terminal 14 via the Internet NW (step A6, advertisement sending processing). The selected company advertisement is received by the customer terminal 14 via the Internet NW (step A7, advertisement receiving processing). Billing information M10c corresponding to the advertising sending processing (step A6) is sent from the advertising server 10 to the company terminals 11, 12, and 13, via the Internet NW (step A8, billing information sending processing). The billing information 10c is received by the corresponding company terminals (step A9, billing information receiving processing). Based on the billing information 10c, remuneration for sending of the advertisement is paid to the advertising service agency. The amount of this remuneration can depend, for example, on the number of times an advertisement is sent from the advertising server 10, or the number of advertisement pages.

As described above, in the first embodiment of the present invention, the advertising server 10 generates and discloses a web page having advertisement selection information M10b based on the advertisement request information M11, M12, and M13, and based on the selection information M14 selects and sends a company advertisement to the customer terminal 14, so that it is possible for the customer to read only desired company advertisements, thereby eliminating the time wasted in the conventional technology. Additionally, at the companies as well, wasteful sending of advertising information is eliminated, and it is possible to send to customers only required advertisements, thereby improving the effectiveness of sales activities. It is also possible for the advertising server 10 to gather a large number of advertisers, and this can be expected to improve the advertising income.

(Second Embodiment)

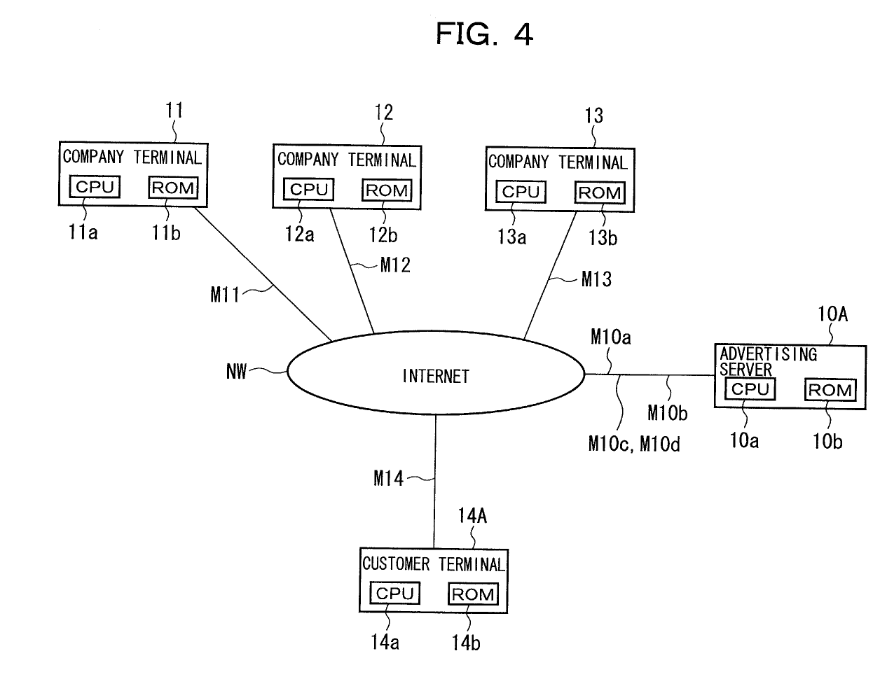

FIG. 4 is a drawing showing the configuration of a advertising network system according to a second embodiment of the present invention, in which elements similar to those in FIG. 1 are assigned similar reference numerals.

In this advertising network system, in place of the advertising server 10 and customer terminal 14 of FIG. 1, an advertising server 10A and customer terminal 14A having an additional function are provided. The advertising server 10A, in addition to the function of the advertising server 10, has a function of sending a second billing information M10d to the customer terminal 14A for the purpose of billing the customer for the sending of an advertisement. The customer terminal 14A, in addition to the function of the customer terminal 14, has a function of receiving this second billing information M10d. Other aspects of the embodiment are the same as shown in FIG. 1.

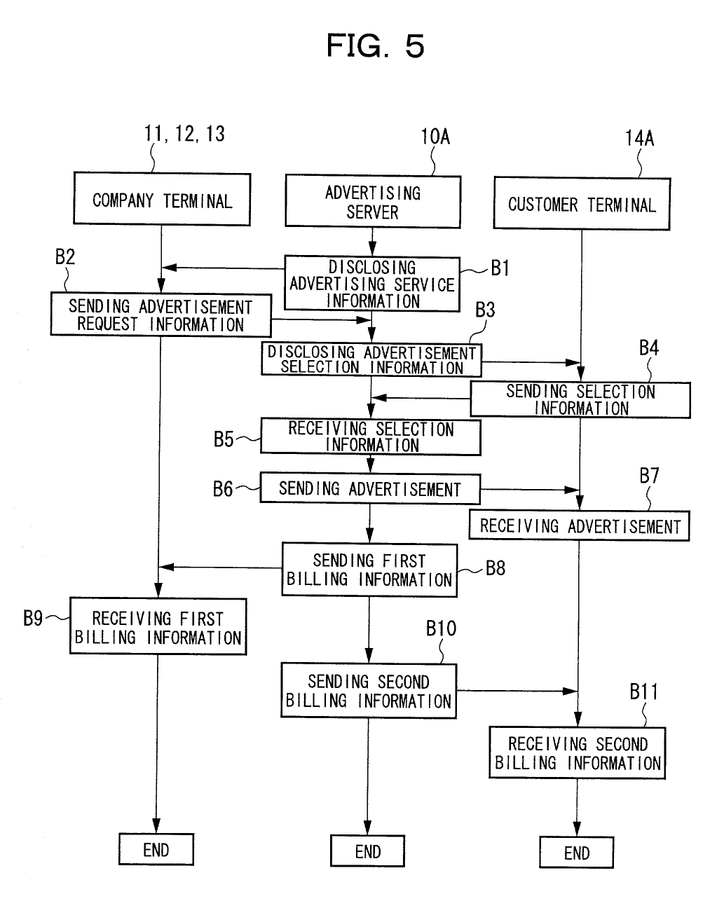

FIG. 5 is a sequence diagram illustrating the advertising network system shown in FIG. 4.

The processing in the advertising network system according to the second embodiment is described below, with reference made to FIG. 5.

Advertising service information M10a from the advertising server 10A is disclosed on the Internet NW (step B1, advertising service information disclosure). The advertising service information M10a is received via the Internet NW by the company terminals 11, 12, and 13. The company terminals 11, 12, and 13, study the content of the advertising service, based on the advertising service information M10a, and each sends to the advertisement server 10 advertising request information M11, M12, and M13, via the Internet NW (step B2, advertisement request information sending processing).

The advertisement request information M11, M12, and M13 is received by the advertising server 10A via the Internet NW. The advertising server 10A, based on the advertisement request information M11, M12, and M13, generates advertisement selection information M10b, and discloses this advertisement selection information M10b on the Internet NW (step B3, advertisement selection information disclosure processing). The advertisement selection information M10b is received by the customer terminal 14A via the Internet NW, and the selection information M14 is sent from the customer terminal 14 to the advertising server 10A via the Internet NW (step B4, selection information sending processing).

The selection information M14 is received by the advertising server 10A via the Internet NW (step B5, selection information receiving processing). The advertising server 10A, selects a company advertisement from advertisement request information M11, M12, and M13, based on the selection information M14, and sends the advertisement to the customer terminal 14A via the Internet NW (step B6, advertisement sending processing). The selected company advertisement is received by the customer terminal 14A via the Internet NW (step B7, advertisement receiving processing).

First billing information M10c corresponding to the advertising sending processing (step B6) is sent from the advertising server 10A to the company terminals 11, 12, and 13, via the Internet NW (step B8, first billing information sending processing). The billing information 10c is received by the corresponding company terminals (step B9, first billing information receiving processing) Second billing information M10d is sent by the advertising server 10A to the customer terminal 14A via the Internet NW (step B10, second billing information sending processing). The second billing information M10d is received by the customer terminal 14A (step B11, second billing information receiving processing).

As described above, in the second embodiment of the present invention, because the billing information M10d is sent to the customer terminal 14A and billing is made to the customer for sending of advertisements, in addition to the advantage of the first embodiment, careful selection is made of advertisements at the customer, this leading to the expectation of an improvement in the quality of company advertisements.

(Third Embodiment)

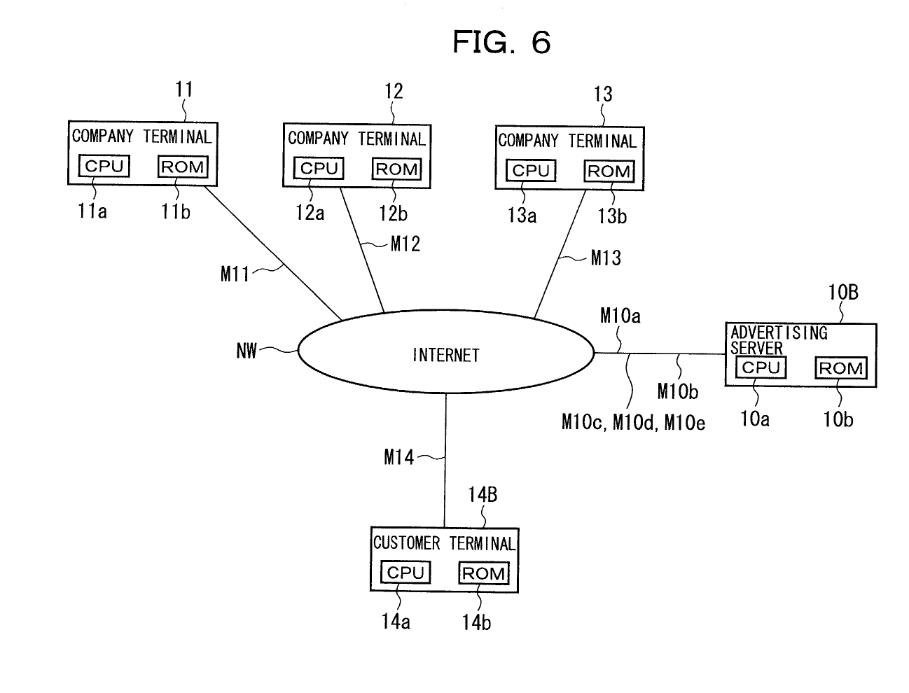

FIG. 6 is a drawing showing the configuration of a advertising network system according to a third embodiment of the present invention, in which elements similar to those in FIG. 1 are assigned similar reference numerals.

In this advertising network system, in place of the advertising server 10 and customer terminal 14 of FIG. 1, an advertising server 10B and customer terminal 14B having an additional function are provided. The advertising server 10B, in addition to the function of the advertising server 10, has a function of sending advertisement receiving fee payment information M10e to the customer terminal 14B for the purpose of paying to the customer an advertisement receiving fee for advertisements sent to the customer terminal 14B. The customer terminal 14B, in addition to the function of the customer terminal 14, has a function of receiving this advertisement receiving fee payment information M10e. Other aspects of the embodiment are the same as shown in FIG. 1.

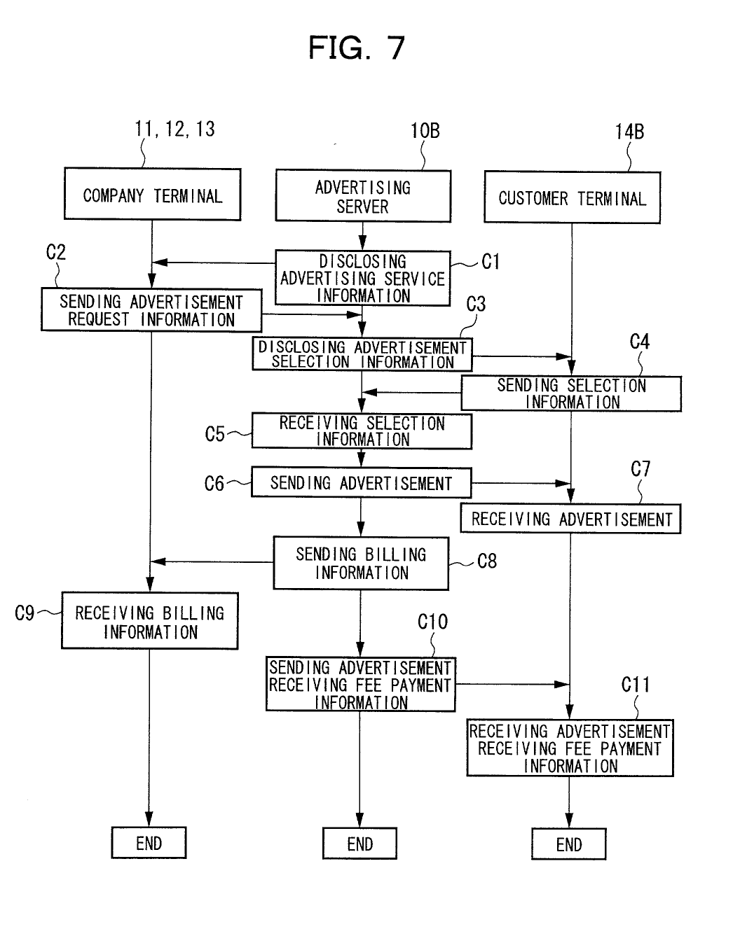

FIG. 7 is a sequence diagram illustrating the advertising network system shown in FIG. 6.

The processing in the advertising network control system according to the third embodiment is described below, with reference made to FIG. 7.

Advertising service information M10a from the advertising server 10B is disclosed on the Internet NW (step C1, advertising service information disclosure). The advertising service information M10a is received via the Internet NW by the company terminals 11, 12, and 13. The company terminals 11, 12, and 13, study the content of the advertising service, based on the advertising service information M10a, and each sends to the advertisement server 10B advertising request information M11, M12, and M13, via the Internet NW (step C2, advertisement request information sending processing).

The advertisement request information M11, M12, and M13 is received by the advertising server 10B via the Internet NW. The advertising server 10B, based on the advertisement request information M11, M12, and M13, generates advertisement selection information M10b, discloses this advertisement selection information M10b on the Internet NW (step C3, advertisement selection information disclosure processing). The advertisement selection information M10b is received by the customer terminal 14B via the Internet NW, and the selection information M14 is sent from the customer terminal 14B to the advertising server 10B via the Internet NW (step C4, selection information sending processing).

The selection information M14 is received by the advertising server 10B via the Internet NW (step C5, selection information receiving processing). The advertising server 10B, selects a company advertisement from advertisement request information M11, M12, and M13, based on the selection information M14, and sends the advertisement to the customer terminal 14B via the Internet NW (step C6, advertisement sending processing). The selected company advertisement is received by the customer terminal 14B via the Internet NW (step C7, advertisement receiving processing).

Billing information M10c corresponding to the advertising sending processing (step C6) is sent from the advertising server 10B to the company terminals 11, 12, and 13, via the Internet NW (step C8, billing information sending processing). The billing information M10c is received by the corresponding company terminals (step C9, billing information receiving processing). Advertisement receiving payment information M10e is sent by the advertising server 10B to the customer terminal 14B via the Internet NW (step C10, advertisement receiving fee payment information sending processing). The advertisement receiving fee payment information M10e is received by the customer terminal 14B (step C11, advertisement receiving fee payment information receiving processing). In this case, at the advertisement receiving processing step (step C7), a compensation payment is made to the customer, because an advertisement from a company unpopular among customers as received at the customer terminal 14B.

As described above, in the third embodiment of the present invention, an advertisement from a company unpopular among customers is received, so that the third embodiment enables the sending of advertisements from even unpopular companies.

The foregoing has been a description of embodiments of the present invention with reference to drawings, and it will be understood that the present invention is not restricted to the above-described embodiments, and further that the present invention can be embodied in various other forms, within the technical scope of the present invention. For example, the customer terminal 14 can be an Internet-connectable PDA (personal digital/data assistant) rather than an personal computer. Additionally, the company terminals 11, 12, and 13 are not restricted to being personal computers, and can alternatively be purpose-built information terminals. In each of the foregoing embodiments, although the advertising servers 10, 10A, and 10B are depicted as parts of the advertising network systems, these can be stand-alone units unrelated to an advertising network system.

As described in detail above, according to the present invention because an advertising server 10A receives advertisement selection information, based on advertisement request information sent from company terminals, and discloses received information via a communication network, and sends company advertisements to a customer terminal in response to advertisement selection information, it is possible for a customer to read only desired advertisements, thereby eliminating the wasted time. Additionally, because the companies avoid sending unwanted advertisements to customer terminals, wasteful transmission of advertisements is eliminated, enabling more efficient targeting of advertisements as a sales activity. Additionally, the advertising server is able to collect a large number of advertisers, thereby increasing advertising income. By billing a customer for receiving an advertisement, the customer is careful in selecting advertisements, and this is expected to improve the quality of advertisements produced by companies. Yet another effect of the present invention is that, because a compensating payment is made to a customer for receiving an advertisement from an unpopular company, it is possible to distribute advertisements from even unpopular companies.

What is claimed is:

1. An advertising system having an advertising server which offers advertising service, a plurality of first terminals which provide advertisements of companies to said advertising server, and a plurality of second terminals of customers which obtain said advertisement from said advertising server, said advertising server, said first terminals, and said second terminals are connected to a communication network, wherein said advertising server comprising:
a first means for disclosing detail information of advertising service offered by said advertising server, on said communication network,
a second means for receiving from said first terminals advertising request information for requesting to advertise on said communication network,
a third means for generating advertisement selection information for causing said customers to select said advertisements based on said advertising request information received from said first terminals, and disclosing said advertisement selection information on said communication network,
a fourth means for receiving from said second terminal selection information which said customer selects from said advertisement selection information,
a fifth means for sending to said second terminal an advertisement which said customer selected, in accordance with said selection information received from said second terminal so as to perform advertising service, and
a sixth means for sending to said first terminal billing information for demanding payment with respect to said advertising service by said advertising server.

2. An advertising system having an advertising server which offers advertising service, a plurality of first terminals which provide advertisements of companies to said advertising server, and a plurality of second terminals of customers which obtain said advertisement from said advertising server, said advertising server, said first terminals, and said second terminals are connected to a communication network, wherein said advertising server comprising:
a first means for disclosing detail information of advertising service offered by said advertising server, on said communication network,
a second means for receiving from said first terminals advertising request information for requesting to advertise on said communication network,
a third means for generating advertisement selection information for causing said customers to select said advertisements based on said advertising request information received from said first terminals, and disclosing said advertisement selection information on said communication network,
a fourth means for receiving from said second terminal selection information which said customer selects from said advertisement selection information,
a fifth means for sending to said second terminal an advertisement which said customer selected, in accordance with said selection information received from said second terminal so as to perform advertising service,
a sixth means for sending to said first terminal first billing information for demanding payment with respect to said advertising service by said advertising server, and
a seventh means for sending to said second terminal second billing information for demanding payment with respect to said advertising service by said advertising server.

3. An advertising method using an advertising system having an advertising server which offers advertising service, a plurality of first terminals which provide advertisements of companies to said advertising server, and a plurality of second terminals of customers which obtain said advertisement from said advertising server, said advertising server, said first terminals, and said second terminals are connected to a communication network, wherein said advertising server comprising the steps of:
disclosing detail information of advertising service offered by said advertising server, on said communication network,
receiving from said first terminals advertising request information for requesting to advertise on said communication network,
generating advertisement selection information for causing said customers to select said advertisements based on said advertising request information received from said first terminals, and disclosing said advertisement selection information on said communication network,
receiving from said second terminal selection information which said customer selects from said advertisement selection information,
sending to said second terminal an advertisement which said customer selected, in accordance with said selection information received from said second terminal so as to perform advertising service, and
sending to said first terminal billing information for demanding payment with respect to said advertising service by said advertising server.

4. An advertising method using an advertising system having an advertising server which offers advertising service, a plurality of first terminals which provide advertisements of companies to said advertising server, and a plurality of second terminals of customers which obtain said advertisement from said advertising server, said advertising server, said first terminals, and said second terminals are connected to a communication network, wherein said advertising server comprising the steps of:
disclosing detail information of advertising service offered by said advertising server, on said communication network,
receiving from said first terminals advertising request information for requesting to advertise on said communication network,
generating advertisement selection information for causing said customers to select said advertisements based on said advertising request information received from said first terminals, and disclosing said advertisement selection information on said communication network,
receiving from said second terminal selection information which said customer selects from said advertisement selection information,
sending to said second terminal an advertisement which said customer selected, in accordance with said selection information received from said second terminal so as to perform advertising service,
sending to said first terminal first billing information for demanding payment with respect to said advertising service by said advertising server, and
sending to said second terminal second billing information for demanding payment with respect to said advertising service by said advertising server.

5. A computer program for an advertising system having an advertising server which offers advertising service, a plurality of first terminals which provide advertisements of companies to said advertising server, and a plurality of second terminals of customers which obtain said advertisement from said advertising server, said advertising server, said first terminals, and said second terminals are connected to a communication network, wherein said computer program causing said advertising server to execute a method comprising the steps of:
disclosing detail information of advertising service offered by said advertising server, on said communication network,
receiving from said first terminals advertising request information for requesting to advertise on said communication network,
generating advertisement selection information for causing said customers to select said advertisements based on said advertising request information received from said first terminals, and disclosing said advertisement selection information on said communication network,
receiving from said second terminal selection information which said customer selects from said advertisement selection information,
sending to said second terminal an advertisement which said customer selected, in accordance with said selection information received from said second terminal so as to perform advertising service, and
sending to said first terminal billing information for demanding payment with respect to said advertising service by said advertising server.

6. A computer program for an advertising system having an advertising server which offers advertising service, a plurality of first terminals which provide advertisements of companies to said advertising server, and a plurality of second terminals of customers which obtain said advertisement from said advertising server, said advertising server, said first terminals, and said second terminals are connected to a communication network, wherein said computer program causing said advertising server to execute a method comprising the steps of:
disclosing detail information of advertising service offered by said advertising server, on said communication network,
receiving from said first terminals advertising request information for requesting to advertise on said communication network,
generating advertisement selection information for causing said customers to select said advertisements based on said advertising request information received from said first terminals, and disclosing said advertisement selection information on said communication network,
receiving from said second terminal selection information which said customer selects from said advertisement selection information,
sending to said second terminal an advertisement which said customer selected, in accordance with said selection information received from said second terminal so as to perform advertising service,
sending to said first terminal first billing information for demanding payment with respect to said advertising service by said advertising server, and
sending to said second terminal second billing information for demanding payment with respect to said advertising service by said advertising server.
